(19) United States
(12) Patent Application Publication
(10) Pub. No.: US 2023/0128421 A1
(43) Pub. Date: Apr. 27, 2023

(54) NEURAL NETWORK ACCELERATOR

(71) Applicant: Shenzhen Corerain Technologies Co., Ltd., Shenzhen (CN)

(72) Inventors: Chenglong Zeng, Shenzhen (CN); Yuanchao Li, Shenzhen (CN); Kuen Hung Tsoi, Shenzhen (CN); Xinyu Niu, Shenzhen (CN)

(21) Appl. No.: 18/145,014

(22) Filed: Dec. 21, 2022

Related U.S. Application Data
(63) Continuation of application No. PCT/CN2021/100369, filed on Jun. 16, 2021.

(30) Foreign Application Priority Data
Jun. 22, 2020 (CN) 202010574432.9

(51) Int. Cl. G06N 3/0464

(52) U.S. Cl. CPC G06N 3/0464

(57) ABSTRACT

An embodiment of the present application discloses a neural network accelerator, including: a convolution calculation module, which is used to perform a convolution operation on an input data input into a preset neural network to obtain a first output data; a tail calculation module, which is used to perform a calculation on the first output data to obtain a second output data; a storage module, which is used to cache the input data and the second output data; and a first control module, which is used to transmit the first output data to the tail calculation module. The convolution calculation module includes a plurality of convolution calculation units, the tail calculation module includes a plurality of tail calculation units, the first control module includes a plurality of first control units, and at least two convolution calculation units are connected to one tail calculation unit through one first control unit.

### CROSS REFERENCE TO RELATED APPLICATIONS

The present application is a Continuation Application of PCT Application No. PCT/CN2021/100369 filed on Jun. 16, 2021, which claims the priority of a Chinese patent application with application number 202010574432.9 filed with the China Patent Office on Jun. 22, 2020, the entire content of which is incorporated herein by reference.

### TECHNICAL FIELD

An embodiment of the present application relates to the technical field of neural networks, for example, to a neural network accelerator.

### BACKGROUND

In recent years, convolutional neural networks have developed rapidly and are widely used in computer vision and natural language processing. However, the improvement in the accuracy of convolutional neural networks is accompanied by a rapid increase in computational cost and storage cost. It is difficult to provide enough computing power using a multi-core central processing unit (CPU). Although the graphics processing unit (GPU) can process complex convolutional neural network models at high speed, the power consumption is too high, and its application in embedded systems is limited.

Convolutional neural network accelerators based on FPGAs and ASICs which have features of high energy efficiency and massively parallel processing, have gradually become a hot research topic. Since the convolutional neural network has a large number of parameters and requires a large number of multiplication and addition operations, in order to achieve high processing performance of the convolutional neural network under limited resources, the main problem to be solved by these accelerators is how to increase parallelism and reduce memory bandwidth requirements.

In related technologies, when improving performance, it is mainly optimized for the convolutional layer or the fully connected layer. However, in a highly versatile convolutional neural network accelerator, the convolutional layer is often connected with pooling, activation, shortcut, and up-sampling and other subsequent processing operations, these operations are named tail calculations here, and the optimization of these operations is also crucial in the design of convolutional neural network accelerators.

### SUMMARY

An embodiment of the present application provides a neural network accelerator, so as to optimize the tail calculation in the neural network accelerator and reduce resource consumption.

The embodiment of the present application provides a neural network accelerator, including: a convolution calculation module used to perform a convolution operation on an input data input into a preset neural network to obtain a first output data;

a tail calculation module used to perform a calculation on the first output data to obtain a second output data;

a storage module used to cache the input data and the second output data; and

a first control module used to transmit the first output data to the tail calculation module; the convolution calculation module includes a plurality of convolution calculation units, the tail calculation module includes a plurality of tail calculation units, the first control module includes a plurality of first control units, and at least two convolution calculation units are connected to one tail calculation unit through one first control unit.

Optionally, the neural network accelerator further includes a second control module used to transmit the output data calculated by the neural network to the storage module, the second control module including a plurality of second control units, and at least one tail calculation unit being connected to the storage module through one second control unit.

Optionally, a data flow rate of the convolution calculation module is less than or equal to a data flow rate of the tail calculation module.

Optionally, a sum of on-chip resources consumed by the convolution calculation module and the tail calculation module is less than or equal to a total on-chip resource. Optionally, the neural network accelerator further includes: a preset parameter configuration module used to configure preset parameters, the preset parameters including a convolution kernel size, an input feature map size, an input data storage location and a second output data storage location.

Optionally, each convolution calculation unit includes a weight value unit, an input feature map unit, and a convolution kernel;

the weight value unit is used to form a corresponding weight value according to the convolution kernel size;

the input feature map unit is used to obtain the input data from the storage module according to the input feature map size and the input data storage location to form a corresponding input feature map;

the convolution kernel is used to perform a calculation on the weight value and the input feature map.

Optionally, each convolution calculation unit is used to perform the calculation on the weight value and the input feature map to obtain the first output data.

Optionally, the storage module includes an on-chip memory and/or an off-chip memory.

Optionally, when the input data storage location is an off-chip memory, the input data in the off-chip memory is transmitted to the on-chip memory through a DMA.

Optionally, when the second output data storage location is an off-chip memory, the second output data is transmitted to the off-chip memory by a DMA.

The neural network accelerator provided in Embodiment 1 of the present application, by including a convolution calculation module used to perform a convolution operation on an input data input into a preset neural network to obtain a first output data, a tail calculation module used to perform a calculation on the first output data to obtain a second output data, a storage module used to cache the input data and the second output data, a first control module used to transmit the first output data to the tail calculation module, the convolution calculation module including a plurality of convolution calculation units, the tail calculation module including a plurality of tail calculation units, the first control module including a plurality of first control units, and at least two convolution calculation units being connected to one tail calculation unit through one first control unit, optimizes design of the tail calculation module in the neural network accelerator, and reduces the resource consumption of the neural network accelerator.

### BRIEF DESCRIPTION OF THE DRAWINGS

FIG. 1 is a schematic structural diagram of a neural network accelerator provided in Embodiment 1 of the present application;

FIG. 2 is a schematic structural diagram of a neural network accelerator provided in Embodiment 2 of the present application;

FIG. 3 is a schematic structural diagram of a neural network accelerator provided in Embodiment 3 of the present application.

### DETAILED DESCRIPTION

The application will be described below in conjunction with the accompanying drawings and embodiments. It should be understood that the specific embodiments described here are only used to explain the present application, but not to limit the present application. In addition, it should be noted that, for the convenience of description, only some structures related to the present application, but not all structures, are shown in the drawings.

Some exemplary embodiments are described as processes or methods depicted as flowcharts. Although the flowcharts describe the steps as sequential processing, many of the steps may be performed in parallel, concurrently, or simultaneously. Additionally, the order of steps may be rearranged. A process may be terminated when its operations are complete, but may also have additional steps not included in the drawings. A process may correspond to a method, function, procedure, subroutine, subprogram, or the like.

In addition, the terms “first”, “second”, etc. may be used herein to describe various directions, actions, steps or elements, etc., but these directions, actions, steps or elements are not limited by these terms. These terms are only used to distinguish a first direction, action, step or element from another direction, action, step or element. For example, a first output data could be termed a second output data, and, similarly, a second output data could be termed a first output data, without departing from the scope of the present application. Both the first output data and the second output data are output data, but they are not the same output data. The terms “first”, “second”, etc. should not be interpreted as indicating or implying relative importance or implying the number of indicated technical features. Thus, a feature defined as “first” and “second” may explicitly or implicitly include one or more of these features. In the description of the present application, “plurality” means at least two, such as two, three, etc., unless otherwise specifically defined.

### Embodiment 1

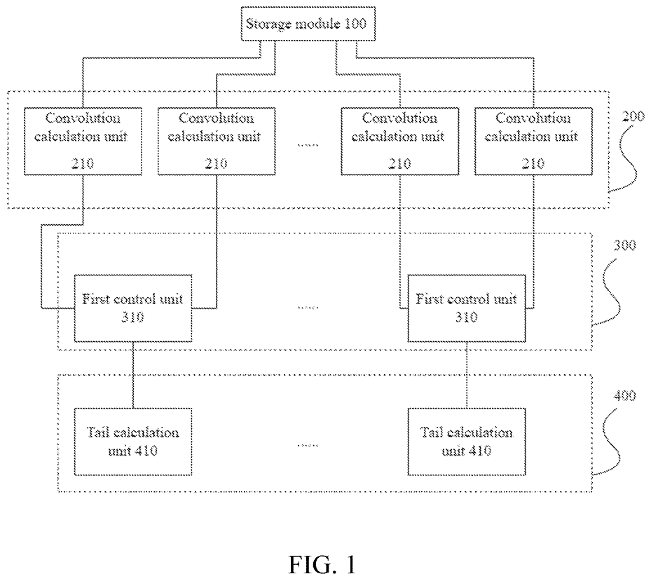

FIG. 1 is a schematic structural diagram of a neural network accelerator provided in Embodiment 1 of the present application, which is applicable to the calculation of neural networks. As shown in FIG. 1, the neural network accelerator provided by Embodiment 1 of the present application includes: a storage module 100, a convolution calculation module 200, a first control module 300 and a tail calculation module 400. The convolution calculation module 200 is used to perform a convolution operation on an input data input into a preset neural network to obtain a first output data; the tail calculation module 400 is used to perform a calculation on the first output data to obtain a second output data; the storage module 100 is used to cache the input data and the second output data; the first control module 300 is used to transmit the first output data to the tail calculation module.

Optionally, the convolution calculation module 200 includes a plurality of convolution calculation units 210, the tail calculation module 400 includes a plurality of tail calculation units 410, the first control module 300 includes a plurality of first control units 310, and at least two convolution calculation units 210 are connected to one tail calculation unit 410 through one first control unit 310.

Exemplarily, taking two convolution calculation units 210 being connected to one tail calculation unit 410 through one first control unit 310 as an example, when using a neural network accelerator to perform calculations on a neural network, the input data first undergoes convolution calculations through the convolution calculation module 200, and the first output data output by the convolution calculation module 200 also needs to be processed by the tail calculation module 400, such as pooling, activation, shortcut, up-sampling, etc., these processes are collectively referred to as the tail calculation, and at last the tail calculation module 400 outputs the second output data finally obtained by the calculation of the neural network accelerator.

Exemplarily, the first convolution calculation unit 210 is denoted as PE1, and the first output data calculated by it is denoted as PI1, and the second convolution calculation unit 210 is denoted as PE2, and the first output data obtained by it is denoted as for PI2. Since the convolutional neural network adopts a parallel calculation method, that is, the convolution calculation unit PE1 and the convolution calculation unit PE2 perform calculations at the same time, then the first output data PI1 and the first output data PI2 will be input into the first control unit 310 at the same time, and a tail calculation unit 410 can only perform tail calculation on one first output data at a time. Therefore, the first control unit 310 firstly inputs the first output data PI1 into the tail calculation unit 410, and caches the first output data PI2 at the same time. When the tail calculation unit 410 completes the tail calculation on the first output data PI1, the first control unit 310 then inputs the cached first output data PI2 into the tail calculation unit 410 for calculation.

In this embodiment, two convolution calculation units 210 are connected to a tail calculation unit 410 through a first control unit 310, and the first output data output by one of the two convolution calculation units 210 through the first control unit 310 is alternately output to the tail calculation unit 410, so that two convolution calculation units share one tail calculation unit 410, reducing the number of tail calculation units 410, thereby reducing resource consumption of the neural network accelerator.

The neural network accelerator provided in Embodiment 1 of the present application, by including a convolution calculation module used to perform a convolution operation on an input data input into a preset neural network to obtain a first output data, a tail calculation module used to perform a calculation on the first output data to obtain a second output data, a storage module used to cache the input data and the second output data, a first control module used to transmit the first output data to the tail calculation module, the convolution calculation module including a plurality of convolution calculation units, the tail calculation module including a plurality of tail calculation units, the first control module including a plurality of first control units, and at least two convolution calculation units being connected to one tail calculation unit through one first control unit, optimizes design of the tail calculation module in the neural network accelerator, and reduces the resource consumption of the neural network accelerator.

### Embodiment 2

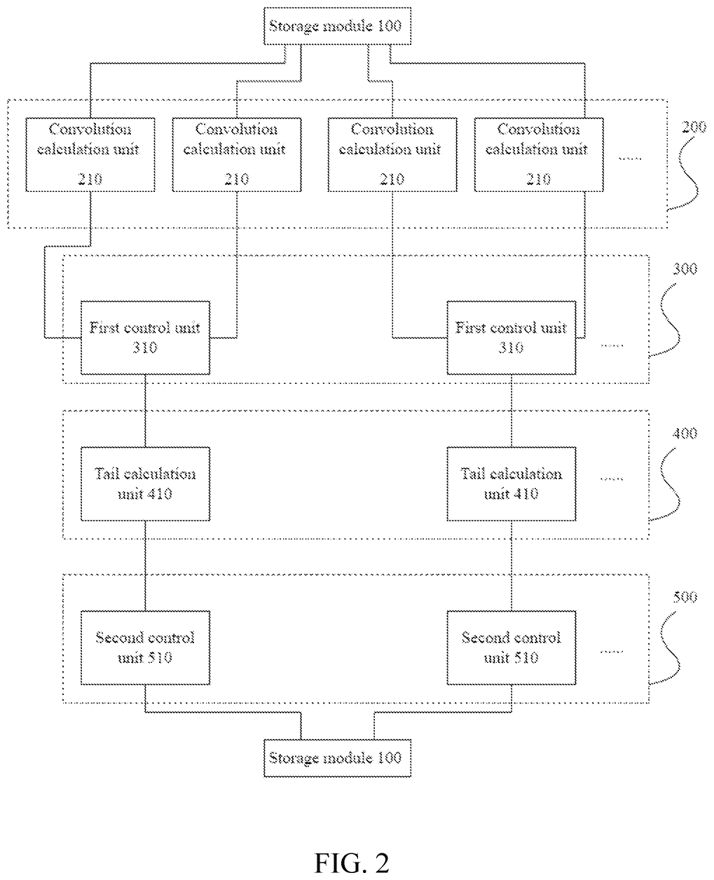

FIG. 2 is a schematic structural diagram of a neural network accelerator provided in Embodiment 2 of the present application. This embodiment is a refinement of the foregoing embodiment. As shown in FIG. 2, the neural network accelerator provided by Embodiment 2 of the present application includes: a storage module 100, a convolution calculation module 200, a first control module 300, a tail calculation module 400 and a second control module 500. The convolution calculation module 200 is used to perform a convolution operation on an input data input into a preset neural network to obtain a first output data; the tail calculation module 400 is used to perform a calculation on the first output data to obtain a second output data; the storage module 100 is used to cache the input data and the second output data; the first control module 300 is used to transmit the first output data output by the convolution calculation module 200 to the tail calculation module 400; and the second control module 500 is used to transmit the second output data output by the tail calculation module 400 to the storage module 100.

Optionally, the convolution calculation module 200 includes a plurality of convolution calculation units 210, the tail calculation module 400 includes a plurality of tail calculation units 410, the first control module 300 includes a plurality of first control units 310, and the second control module 500 includes a plurality of second control units 510. At least two convolution calculation units are connected to a tail calculation unit 410 through one first control unit 310, and at least one tail calculation unit 410 is connected to a storage module 100 through a second control unit 510. When using a neural network accelerator to perform calculations on a neural network, the input data first undergoes convolution calculations through the convolution calculation module 200, and the first output data output by the convolution calculation module 200 also needs to be processed by the tail calculation module 400, such as pooling, activation, shortcut (direct connection), up-sampling, etc., these processes are collectively referred to as the tail calculation, and at last the tail calculation module 400 outputs the second output data finally obtained by the calculation of the neural network accelerator.

Exemplarily, as shown in FIG. 2, taking that two convolution calculation units 210 being connected to a tail calculation unit 410 through a first control unit 310, and a tail calculation unit 410 being connected to a storage module through a second control unit 510 as an example, the first convolution calculation unit 210 is denoted as PE1, and the first output data obtained by it is denoted as PI1, and the second convolution calculation unit 210 is denoted as PE2, and the first output data calculated by it is denoted as PI2, the second output data obtained by performing the tail calculation on the first output data PI1 through the tail calculation unit 410 is denoted as PO1, and the second output data obtained by performing the tail calculation on the first output data PI2 through the tail calculation unit 410 is denoted as PO2. Since the convolutional neural network adopts a parallel calculation method, that is, the convolution calculation unit PE1 and the convolution calculation unit PE2 perform calculations at the same time, then the first output data PI1 and the first output data PI2 will be input into the first control unit 310 at the same time, and a tail calculation unit 410 can only perform tail calculation on one first output data at a time. Therefore, the first control unit 310 firstly inputs the first output data PI1 into the tail calculation unit 410, and caches the first output data PI2 at the same time. When the tail calculation unit 410 completes the tail calculation on the first output data PI1, the first control unit 310 then inputs the cached first output data PI2 into the tail calculation unit 410 for calculation. When the tail calculation unit 410 completes the tail calculation on the first output data PI1, it also inputs the obtained second output data PO1 into the second control unit 510. Normally, the output data calculated by the neural network accelerator needs to be output at the same time. Therefore, when the second control unit 510 receives the second output data PO1, the calculation of the first output data PI2 has not been completed at this time, and the second output data PO2 cannot be obtained, the second control unit 510 firstly caches the second output data PO1, and only stores the second output data PO1 and the second output data PO2 in the storage module at the same time when receiving the second output data PO2 transmitted by the tail calculation unit 410.

In this embodiment, the data input and output mode of the first control unit 310 is called 2 in 1 out, that is, the first control unit 310 receives two first output data at the same time, but one first output data is output each time. The data input and output mode of the second control unit 510 is called 1 in 2 out, that is, the first control unit 310 receives one second output data each time, but simultaneously outputs two second output data. Optionally, if two tail calculation units 410 are connected to the storage module 100 through a second control unit 510, then it is equivalent to the second control unit 510 receiving two second output data at the same time, then simultaneously outputting four second output data.

Optionally, the data flow rate of the convolution calculation module 200 is less than or equal to the data flow rate of the tail calculation module 400. The data flow rate of the convolution calculation module 200 refers to the sum of the data flow rates in all convolution calculation units 210, and the data flow rate of the tail calculation module 400 refers to the sum of the data flow rates in all tail calculation units 410. Because at least two convolution calculation units 210 are connected to a tail calculation unit 410 through a first control unit 310, that is, the number of tail calculation units 410 is less than the number of convolution calculation units 210, and the number of tail calculation units 410 is usually an integer multiple of the convolution calculation units 210. The data flow rate of the tail calculation module 400 is greater than or equal to the data flow rate of the convolution calculation module 200, in order to ensure that the tail calculation module 400 can process the first output data of the convolution calculation module 200 in time, so as to ensure the smoothness of data flow. Assuming that the number of convolution calculation units 210 is n, the data flow rate in each convolution calculation unit 210 is v1 (that is, the amount of data processed by each convolution calculation unit 210 per unit time), and the number of tail calculation units 410 is m, the data flow rate in each tail calculation unit 410 is v2 (that is, the amount of data processed by each tail calculation unit 410 per unit time), then m*v2≥n*v1.

Optionally, the sum of the on-chip resources consumed by the convolution calculation module 200 and the on-chip resources consumed by the tail calculation module 400 is less than or equal to the total on-chip resources. The on-chip resources consumed by the convolution calculation module 200 refer to the sum of the on-chip resources consumed by all the convolution calculation units 210. The on-chip resources consumed by the convolution calculation unit 210 refer to the storage resources (Memory), calculation resources (such as LUT (Look-Up-Table), DSP (Digital Signal Processing)), and system resources, etc, consumed by the convolution calculation unit 210 for calculation. The on-chip resources consumed by the tail calculation module 400 refer to the sum of the on-chip resources consumed by all the tail calculation units 410. The on-chip resources consumed by the tail calculation unit 410 refer to the storage resources (Memory), calculation resources (such as LUT (Look-Up-Table), DSP (Digital Signal Processing)), and system resources, etc, consumed by the tail calculation unit 410 for calculation. Assuming that the number of convolution calculation units 210 is n, the on-chip resource consumed by each convolution calculation unit 210 is x, the number of tail calculation units 410 is m, the on-chip resource consumed by each tail calculation unit 410 is y, and the total on-chip resources are z, then, m*y+n*x≤z.

In the second embodiment of the present application, a second control module is configured to transmit the output data calculated by the neural network to the storage module, the second control module includes a plurality of second control units, and at least one tail calculation unit is connected to the storage module through one second control unit to control the rate at which the tail calculation unit transmits data to the storage module through the second control unit. When the amount of data is large, the second control unit acts as a buffer effect.

### Embodiment 3

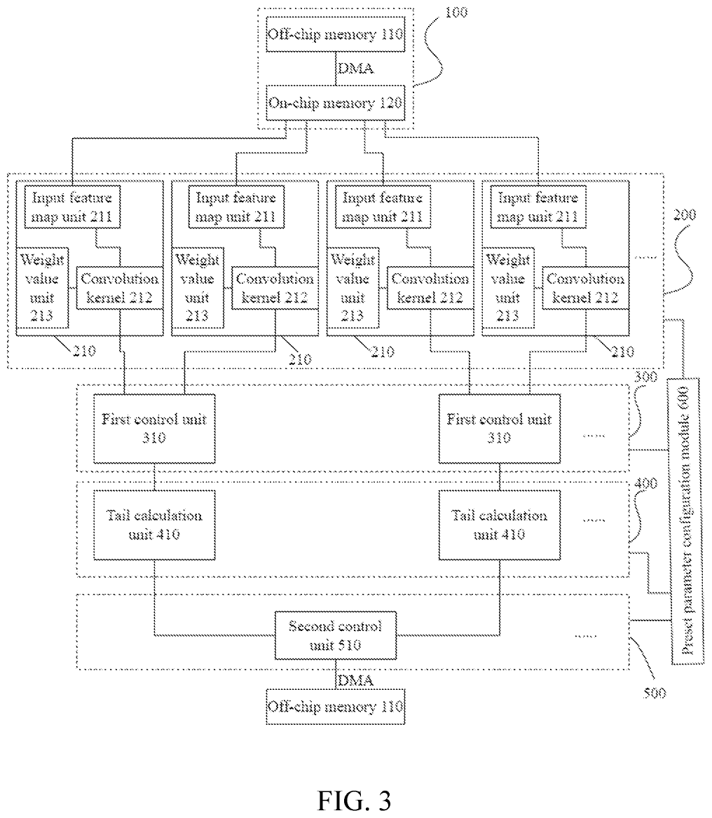

FIG. 3 is a schematic structural diagram of a neural network accelerator provided in Embodiment 3 of the present application. This embodiment is a refinement of the storage module and the convolution calculation unit in the foregoing embodiment. As shown in FIG. 3, the neural network accelerator provided by Embodiment 3 of the present application includes: a storage module 100, a convolution calculation module 200, a first control module 300, a tail calculation module 400, a second control module 500 and a preset parameter configuration module 600. The convolution calculation module 200 is used to perform convolution operation on the input data of the preset neural network to obtain the first output data; the tail calculation module 400 is used to perform the calculation on the first output data to obtain the second output data; the storage module 100 is used to cache the input data and the second output data; the first control module 300 is used to transmit the first output data output by the convolution calculation module 200 to the tail calculation module 400; the second control module 500 is used to transmit second first output data output by the tail calculation module 400 to the storage module 100; and the preset parameter configuration module 600 is used to configure the preset parameters.

Optionally, the convolution calculation module 200 includes a plurality of convolution calculation units 210, the tail calculation module 400 includes a plurality of tail calculation units 410, the first control module 300 includes a plurality of first control units 310, and at least two convolution calculation units are connected to a tail calculation unit 410 through a first control unit 310. The second control module 500 includes a plurality of second control units 510, and at least one tail calculation unit is connected to the storage module 100 through one second control unit 510. Exemplarily, the neural network accelerator shown in FIG. 3 shows that two convolution calculation units are connected to a tail calculation unit 410 through a first control unit 310, and two tail calculation units are connected to a storage module 100 through a second control unit 510.

Optionally, the preset parameters include but not limited to a convolution kernel size, an input feature map size, an input data storage location and a second output data storage location. The convolution calculation of the neural network is usually a multiplication and addition operation between the input data and the corresponding weight value data to obtain the first output data. The data during the calculation is usually expressed in the form of a feature map. For example, the input data is called an input feature map. The first output data is called the first output feature map. The feature map represents an a*b two-dimensional matrix data structure defined by a column and b row, the convolution kernel size represents the size of the weight value, and the input feature map size represents the size of the input feature map. For example, if the convolution kernel size is 3*3, it means that the weight value is a 3*3 two-dimensional matrix data structure, including 9 data.

Optionally, each convolution calculation unit 210 includes an input feature map unit 211, a convolution kernel 212, and a weight value unit 213, and the weight value unit 213 is used to form a corresponding weight value according to the convolution kernel size; the input feature map unit 211 is used to obtain the input data from the storage module according to the input feature map size and the input data storage location to form a corresponding input feature map; and the convolution kernel 212 is used to perform the calculation on the weight value and the input feature map.

Optionally, the storage module 100 includes an off-chip memory 110 and/or an on-chip memory 120, and the input data storage location and the second output data storage location may be an on-chip memory or an off-chip memory. Exemplarily, FIG. 3 takes the off-chip memory as an example. When the input data is stored in the off-chip memory 110, the input data of the off-chip memory 110 is transmitted to the on-chip memory 120 through DMA (Direct Memory Access). The convolution calculation unit 210 can directly obtain the input data from the on-chip memory 120. When the second output data storage location is the off-chip memory, the second control unit 510 directly outputs the second output data to the off-chip memory 110 through DMA. Optionally, when both the input data storage location and the second output data storage location are the on-chip memory, the convolution calculation unit 210 can directly obtain the input data from the on-chip memory, and the second control unit can also directly transmit the second output data to the on-chip memory.

Optionally, due to the characteristics of the convolutional neural network itself, in different network layers, the data flow rates in the convolutional calculation unit and the tail calculation unit may be different. Therefore, for different network layers, the optimal number n of the convolutional calculation units and the optimal number m of the tail calculation units may be different. Therefore, the preset parameter configuration module 600 can also be used to configure in each network layer: the number n of the convolution calculation units, the number of the first control units, and the number m of the tail calculation units, the number of the second control units, the ratio k of the convolution calculation unit to the first control unit, and the ratio q of the tail calculation unit to the second control unit. Among them, the number n of the convolution calculation units and the number m of the tail calculation units can be designed with reference to the following process: from m*v2≥n*v1: n≤m*v2/v1 can be obtained, from m*y+n*x≤z: n≤(z-m*y)/x can be obtained. It can be seen that when m*v2/v1=(z-m*y)/x, the maximum value of n can be obtained, at this time, m=z*v1/(x*v2+y*v1), n=z*v2/(x*v2+y*v1). Since both n and m are integers, and n is an integer multiple of m, so: m=floor[z*v1/(x*v2+y*v1)], n=floor[z*v2/(x*v2+y*v1)], where the floor function means rounding down. Exemplarily, setting z=1000, x=50, y=30, v1=1, v2=2, then m=floor[z*v1/(x*v2+y*v1)]=7, n=floor [z*v2/(x*v2+y*v1)]=14, k=2 can be set at this time, which means that two convolution calculation units are connected to a tail calculation unit through a first control unit. It can be seen that the ratio k of the convolution calculation unit to the first control unit may be set as a ratio of the number n of convolution calculation units to the number m of tail calculation units. Since the second control unit needs to output all the second output data at the same time, the ratio q of the tail calculation unit to the second control unit can be set according to actual needs. For example, setting q=2 means that the two tail calculation units are connected to the storage module through one second control unit, specifically: a second control unit simultaneously receives 2 second output data in one clock cycle, then after two clock cycles, a second control unit simultaneously outputs 4 second output data.

Optionally, because the tail calculation includes but not limited to pooling, activation, shortcut, up-sampling and other processing, but not every neural network needs to perform all tail calculation processing when performing calculations, the preset parameter configuration module 600 can also be used to configure the specific tail calculation processing that needs to be performed. For example, setting the corresponding operation to 1 means that the processing needs to be performed, and setting the corresponding operation to 0 means that the processing does not need to be performed. For example, pooling is set to 1, activation is set to 1, shortcut is set to 0, and up-sampling is set to 0, it means that the tail processing unit only needs to perform pooling and activation operations on the input first output data, and does not perform shortcut and up-sampling operation.

Embodiment 3 of the present application performs preset parameter configuration through the preset parameter configuration module, which can flexibly set and change various preset parameters such as the convolution kernel size, the input feature map size, the input data storage location, and the second output data storage location, thereby improving the design flexibility of neural network accelerators.

What is claimed is:

1. A neural network accelerator, comprising:
a convolution calculation module used to perform a convolution operation on an input data input into a preset neural network to obtain a first output data;
a tail calculation module used to perform a calculation on the first output data to obtain a second output data;
a storage module used to cache the input data and the second output data; and
a first control module used to transmit the first output data to the tail calculation module;
wherein the convolution calculation module includes a plurality of convolution calculation units, the tail calculation module includes a plurality of tail calculation units, the first control module includes a plurality of first control units, and at least two convolution calculation units are connected to one tail calculation unit through one first control unit.

2. The neural network accelerator according to claim 1, further comprising a second control module used to transmit the output data calculated by the neural network to the storage module, the second control module comprising a plurality of second control units, and at least one tail calculation unit being connected to the storage module through one second control unit.

3. The neural network accelerator according to claim 1, wherein a data flow rate of the convolution calculation module is less than or equal to a data flow rate of the tail calculation module.

4. The neural network accelerator according to claim 1, wherein a sum of on-chip resources consumed by the convolution calculation module and the tail calculation module is less than or equal to a total on-chip resource.

5. The neural network accelerator according to claim 1, further comprising: a preset parameter configuration module used to configure preset parameters, the preset parameters comprising a convolution kernel size, an input feature map size, an input data storage location and a second output data storage location.

6. The neural network accelerator according to claim 5, wherein each convolution calculation unit comprises a weight value unit, an input feature map unit, and a convolution kernel;
the weight value unit is used to form a corresponding weight value according to the convolution kernel size;
the input feature map unit is used to obtain the input data from the storage module according to the input feature map size and the input data storage location to form a corresponding input feature map;
the convolution kernel is used to perform a calculation on the weight value and the input feature map.

7. The neural network accelerator according to claim 6, wherein each convolution calculation unit is used to perform the calculation on the weight value and the input feature map to obtain the first output data.

8. The neural network accelerator according to claim 5, wherein the storage module comprises an on-chip memory and/or an off-chip memory.

9. The neural network accelerator according to claim 8, wherein when the input data storage location is an off-chip memory, the input data in the off-chip memory is transmitted to the on-chip memory through a DMA.

10. The neural network accelerator according to claim 8, wherein when the second output data storage location is an off-chip memory, the second output data is transmitted to the off-chip memory by a DMA.
